(19) United States
(12) Patent Application Publication
(10) Pub. No.: US 2017/0196331 A1
(43) Pub. Date: Jul. 13, 2017

(54) CARD HOLDER FOR A PORTABLE DEVICE AND METHOD

(71) Applicant: ROBERT GORDON INDUSTRIES, LTD., New Hyde Park, NY (US)

(72) Inventor: Robert GLUCK, New York, NY (US)

(73) Assignee: ROBERT GORDON INDUSTRIES, LTD., New Hyde Park, NY (US)

(21) Appl. No.: 15/216,293

(22) Filed: Jul. 21, 2016

Related U.S. Application Data
(60) Provisional application No. 62/276,401, filed on Jan. 8, 2016.

(51) Int. Cl. A45C 11/18; F16B 47/00

(52) U.S. Cl. CPC A45C 11/182; F16B 47/003; A45C 2011/002

(57) ABSTRACT

Card holder for a portable device that includes a main opening for receiving at least one card, a back side securable to the portable device, a front wall and a member or plate. The member or plate can include at least one material that provides RF and/or RFID shielding and facilitates attachment to an external mount or magnetic surface

### CROSS-REFERENCE TO RELATED APPLICATIONS

The instant application is a U.S. non-provisional Application that is based on and claims the benefit of U.S. provisional application No. 62/276,401 filed Jan. 8, 2016, the disclosure of which is hereby expressly incorporated by reference thereto in its entirety.

### BACKGROUND OF THE INVENTION

1. Field of the Invention

The present invention generally relates to a card holder for a portable device such as a smart phone in which the card holder includes RF and/or RFID shielding and allows mounting of the portable device when the card holder is attached thereto.

2. Discussion of Background Information

Card holders are known and include those that attach to portable devices such as smart phones. The following US patents show examples of the same; the disclosures of which are incorporated by reference in their entireties: U.S. D738,619 to GLUCK, U.S. D745,278 to GLUCK and U.S. D751,289 to GLUCK. However, these devices have addressed the problem of, among other things, more readily or easily securing the portable device to a magnetic mount when the card holder is attached.

While advances have been made in improving or making improvements to card holders and more easy mounting of portable devices, there is a continuing need for more improvement which provides for additional advantages relating to ease of use, safety and reliability.

### SUMMARY OF THE INVENTION

According to one non-limiting embodiment of the invention, there is provided a card holder for a portable device comprising a main opening or slot for receiving at least one card, a back side securable to the portable device, a front wall, and a member or plate comprising at least one material that provides RF and/or RFID shielding and facilitates attachment to an external mount or magnetic surface.

In embodiments, the card holder is made of a synthetic resin.

In embodiments, the card holder is made of a silicone material.

In embodiments, the card holder further comprises an adhesive layer arranged on the back side.

In embodiments, the card holder further comprises a peel and stick adhesive sheet arranged on the back side.

In embodiments, the attaching and RFID shield member or plate is a metal or steel plate.

In embodiments, the attaching and RFID shield member or plate is integrated into a body of the card holder.

In embodiments, the attaching and RFID shield member or plate is integrated into the front wall of the card holder.

In embodiments, the invention provides for a method of securing a portable device to a magnetic mount comprising mounting the portable device to the magnetic mount via the card holder of any one of the types described herein.

In embodiments, the invention provides for a method of securing a portable device to a magnetic mount comprising securing the card holder of any one of the types described herein to the portable device and mounting the portable device to the magnetic mount via the card holder.

In embodiments, the invention provides for a method of making the card holder of any one of types described herein, wherein the method comprises molding (molding, forming in a mold, injection molding, etc.,) the card holder with the attaching and RFID shield member or plate integrated therein.

In embodiments, the invention provides for a method of making the card holder of any one of the types described herein, wherein the method comprises molding the card holder with the attaching and RFID shield member or plate in-molded therein.

According to one non-limiting embodiment of the invention, there is provided a card holder for a portable device comprising a main opening for receiving at least one card, a back side securable to the portable device, a front wall, and a member or plate that allows for attaching and provides RF and/or RFID shielding. The card may be a credit card, debit card, smart card, etc. The portable device may be a cell phone, smart phone, or other portable electronic device, etc.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a prior art card holder;

FIG. 2 shows a first non-limiting embodiment of a card holder utilizing an integrated magnetic attaching and RFID shield member or plate in accordance with the invention;

FIG. 3 is a cross-section of FIG. 1;

FIG. 4 is a cross-section of FIG. 2 and showing the integrated magnetic attaching and RFID shield member or plate located on a front wall of the card holder;

FIG. 5 is a cross-section of FIG. 2 and showing the front wall without the integrated magnetic attaching and RFID shield member or plate;

FIG. 6 shows the cross-section of FIG. 5 with the integrated magnetic attaching and RFID shield member or plate installed;

FIGS. 7-12 show various views of a second embodiment of a card holder utilizing an integrated magnetic attaching and RFID shield member or plate located on a front wall of the card holder;

FIG. 13 shows the magnetic attaching and RFID shield member or plate used in the embodiment of FIG. 2;

FIG. 14 shows the magnetic attaching and RFID shield member or plate used in the embodiment of FIG. 7;

FIG. 15 shows the card holder of FIG. 2 prior to securing the same to a portable device;

FIG. 16 shows the card holder of FIG. 2 having its back side secured to a portable device;

FIG. 17 shows a portable device with the card holder of FIG. 7 secured thereto;

FIG. 18 shows a magnetic mount having a pivoting attachment portion;

FIG. 19 shows the portable device with the card holder as illustrated in FIG. 17 mounted to the magnetic mount of FIG. 18;

FIGS. 20-24 show various views of a third embodiment of a card holder utilizing an integrated magnetic attaching and RFID shield member or plate located on a front wall of the card holder;

FIGS. 25-30 show various views of a fourth embodiment of a card holder utilizing an integrated magnetic attaching and RFID shield member or plate located on a front wall of the card holder;

FIGS. 31-36 show various views of a fifth embodiment of a card holder utilizing an integrated magnetic attaching and RFID shield member or plate located on a front wall of the card holder;

FIG. 37 shows an alternative magnetic attaching and RFID shield member or plate that can be used in another non-limiting embodiment. The plate differs from that used in FIG. 2 in that it utilizes rounded upper corners and of less thickness; and

FIG. 38 shows a cross-section similar to FIG. 4 and illustrating the thinner plate of FIG. 37 arranged in a card holder of the type shown in FIG. 2.

### DETAILED DESCRIPTION OF THE INVENTION

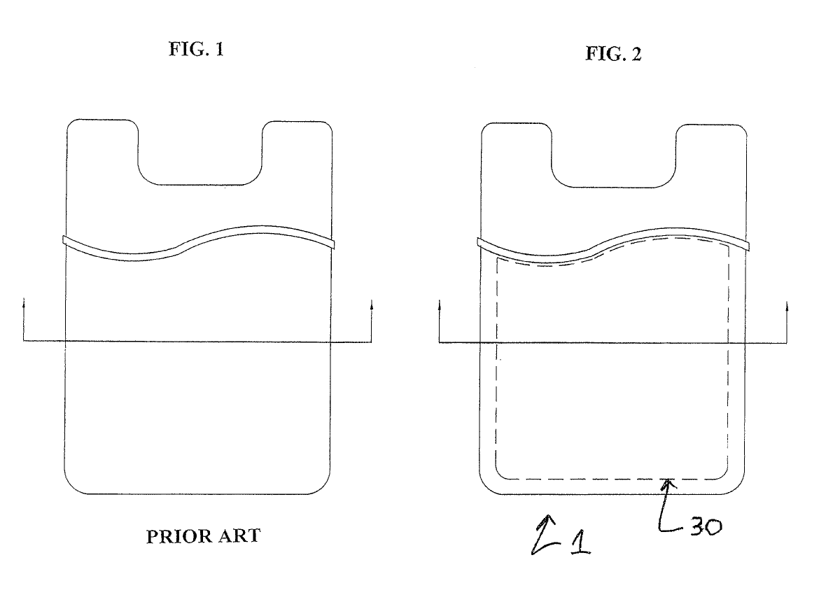

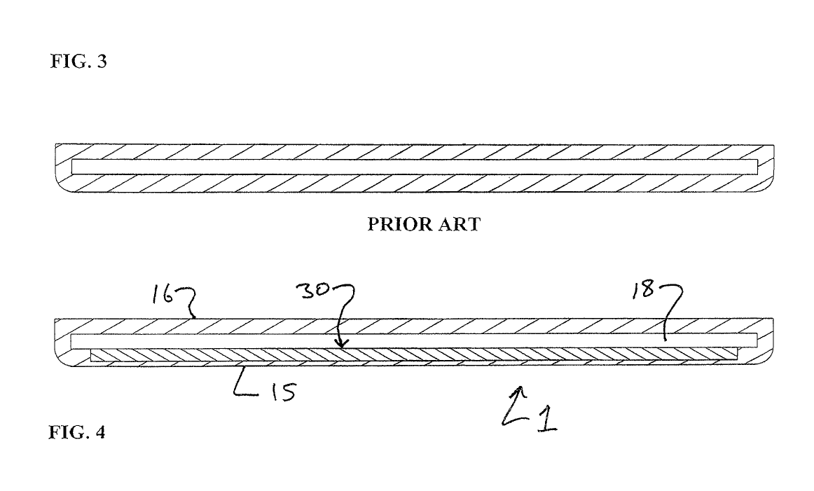

In embodiments of the invention, there is provided a card holder 1 for a portable device PD which can be a portable electronic device such as a phone, smart phone, tablet or other such device. As shown in FIGS. 2 and 4, the holder 1 includes a main opening or slot 18 for receiving at least one card such as a credit card, debit card, or other such devices or card-shaped objects, which can include or be provided with a mechanism, i.e., a magnetic strip or chip for carrying readable and/or writable data. The card holder 1 also includes a back side 16 securable to the portable device, a front wall 15, and a member or plate 30. The member or plate 30 can be or can include one or more materials that shield or provide shielding from RF (radio frequency) and/or RFID (radio frequency identification). The one or more materials can be or can include ferrous or ferromagnetic materials. The member or plate 30 can be dimensioned to be securable to a magnetic mount or holder to allow attaching of the card holder 1 to the same or to allow attaching of the portable device, with the card holder 1 secured thereto, to a magnetic mount or holder.

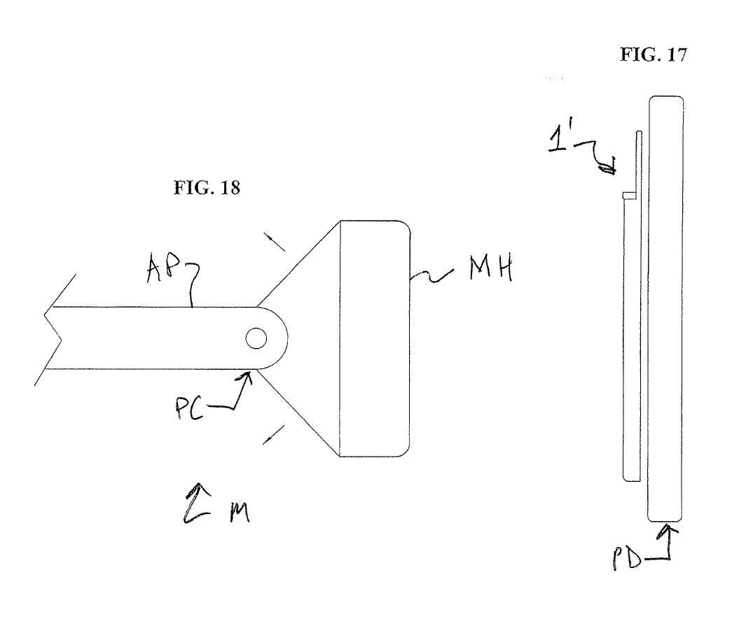

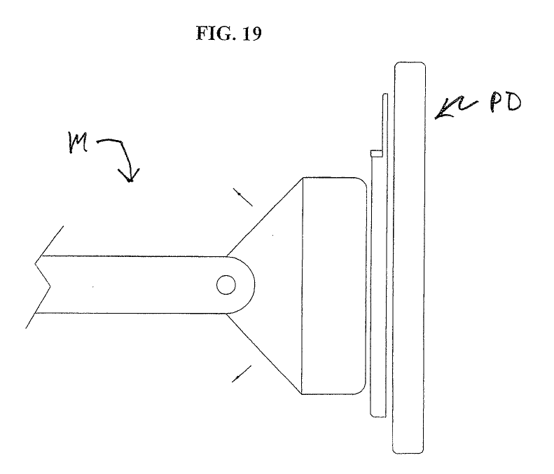

In non-limiting embodiments, the holder 1 can be made of a synthetic resin material such as silicone or rubber. The plate 30 should be sized and shaped to nest inside a wall of the holder 1 and should also be of sufficient mass and thickness to provide RFID shielding and/or to magnetically support the portable device PD when the holder 1 is attached thereto and is magnetically attached to a magnetic mount. See FIG. 19. In embodiments, the plate 30 can also be perforated, or a mesh or screen.

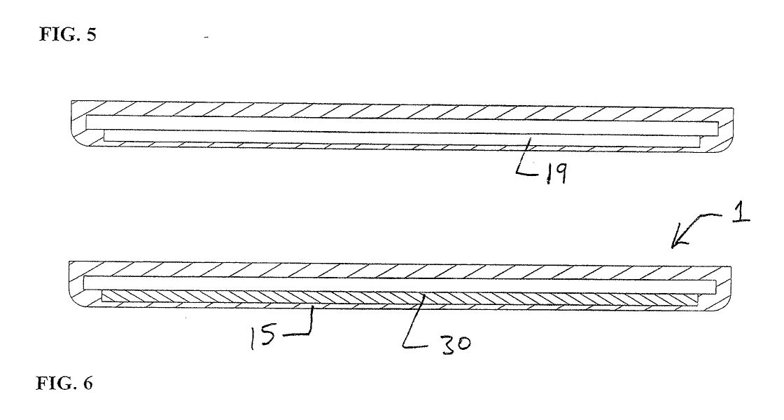

As can be seen in FIG. 5, the plate 30 is seated or nests in a recess 19 formed in the front wall 15 of the holder 1. The plate 30 can be retained in the recess 19 by, e.g., being in-molded or by adhesive attachment.

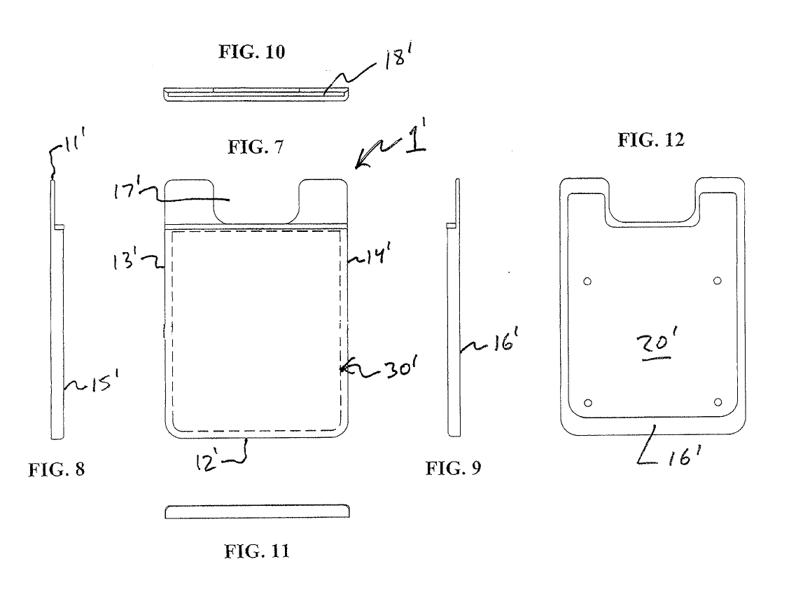

FIGS. 7-12 show another embodiment of a card holder 1′ for a portable device PD which can be a portable electronic device such as a phone, smart phone, tablet or other such device. Like the previous embodiment, the holder 1′ includes a main opening or slot 18′ for receiving at least one card such as a credit card, debit card, or other such devices or card-shaped objects, a back side 16′ securable to the portable device, a front wall 15′, and an attaching and RF (radio frequency) shield member or plate 30′ (shown is hidden lines) in FIG. 7. In addition, an adhesive backing or sheet 20′ is arranged on the back wall 16′ to allow the holder 1′ to be adhesively secured to a portable device PD. Like the previous embodiment, the holder 1′ can be made of a synthetic resin material such as silicone or rubber. The member or plate 30′ is sized and shaped to nest inside the wall 15′ of the holder 1′, is of sufficient size to encompass 75%, 80% or 90% or more of an area of the front wall 15′, and also has a mass and thickness to provide RF and/or RFID shielding and/or to magnetically support the portable device PD when the holder 1′ is attached thereto and is magnetically attached to a magnetic mount. See example of FIG. 19.

In addition, this embodiment has an upper end 11′ with tabs separated by a notch 17′ as well as a closed lower end 12′ and closed sides 13′ and 14′.

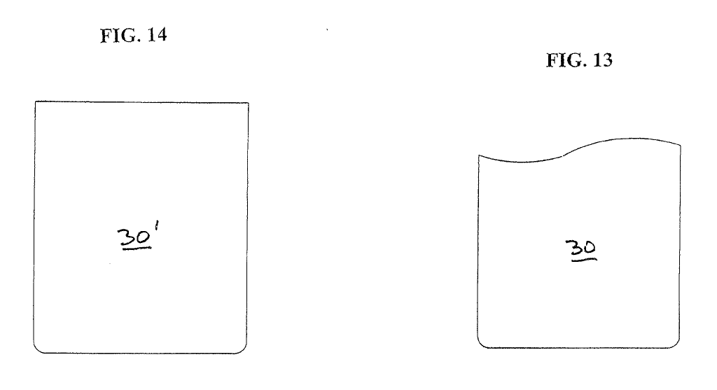

FIG. 13 shows the magnetic attaching and RFID shield member or plate 30 used in the embodiment of FIG. 2. In embodiments, the plate 30 has a shape that corresponds to and is sized to seat or nest in a wall of the holder, is made of a ferrous or magnetic material such as steel (including ferrous sheet metal, stainless steel and galvanized steel), is generally flat in shape and uniform in thickness. In embodiments, the thickness is between about 0.25 mm and 0.75 mm, and preferably around 0.5 mm, and can also be as thick as between 1 mm and about 3 mm. Other-thicknesses may also be utilized including any 0.1 mm increments between 0.1 mm and 3 mm.

FIG. 14 shows the magnetic attaching and RFID shield member or plate 30′ used in the embodiment of FIG. 7. In embodiments, the plate 30′ a shape that is sized to seat or nest in a wall of the holder, is made of a ferrous or magnetic material such as steel, is generally flat in shape and uniform in thickness. In embodiments, the thickness is between about 1 mm and about 3 mm. Other thicknesses may also be utilized.

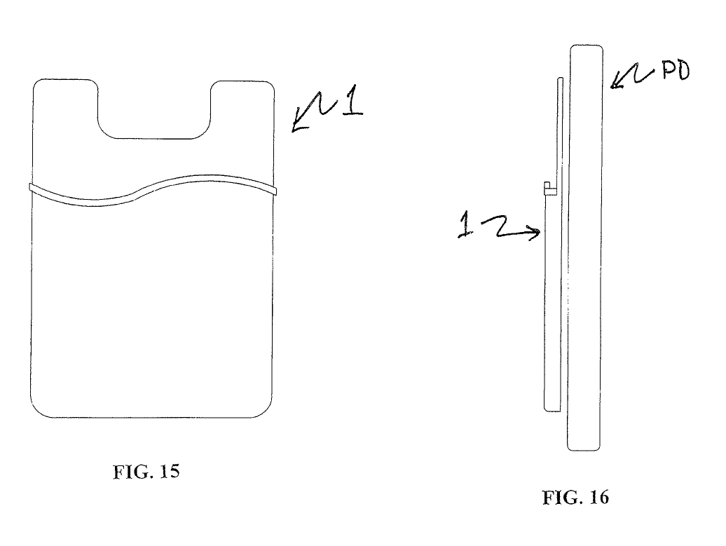

FIG. 15 shows the card holder 1 of FIG. 2 prior to securing the same to a portable device PD. FIG. 16 shows the card holder 1 of FIG. 2 having its back side secured to a portable device PD. This can be accomplished via the adhesive backing similar to element 20′ in FIG. 12. This backing can include a removable or peelable protective layer of the type made by 3M such as 3M 300LSE is removed to expose the adhesive layer that will become attached to a backside of the portable device PD.

FIG. 17 shows the card holder 1′ of FIG. 7 after being secured to a portable device PD. Like the previous embodiment, this can be accomplished via the adhesive backing similar to element 20′ in FIG. 12.

FIG. 18 shows a magnetic mount M having a mount head MH pivotally attached to an attachment portion AP. The attachment portion AP can have an opposite end that facilitates connection to a surface such as vehicle dash board (not shown). The mount head MH can house or retained thereon a magnet such as permanent magnet. The pivot connection PC can be of any type such as a single axis as shown or a multi-axis type joint such as a ball and socket of the type used on some vehicle rear-view mirrors. The magnetic mount head MH should have the ability of magnetically holding and supporting in position the portable device PD with the holder attached thereto. At the same time, the plate 30 protects or provides shielding for any cards placed in the holder.

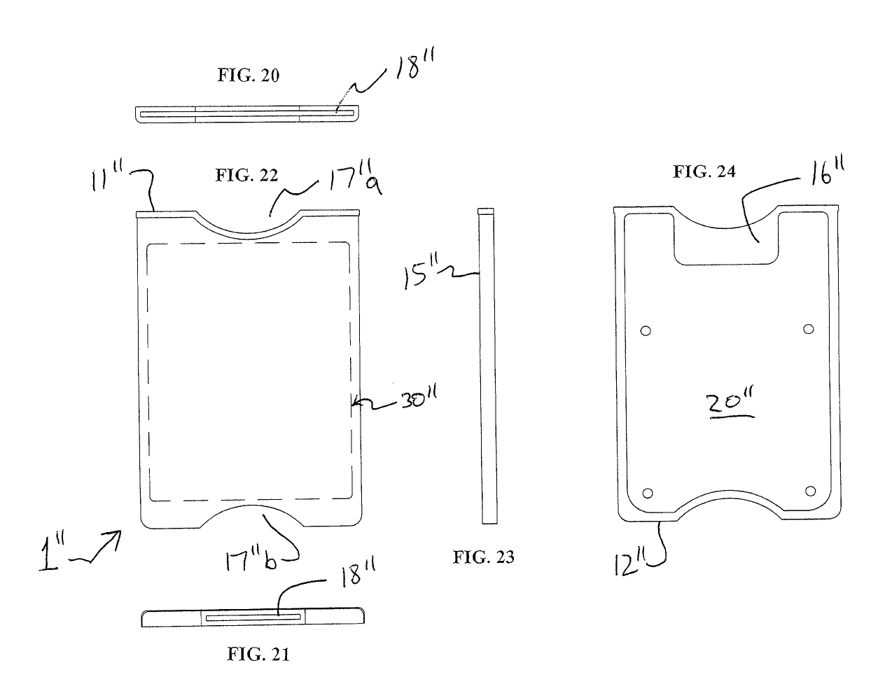

FIGS. 20-24 show another embodiment of a card holder 1″ for a portable device PD which can be a portable electronic device such as a phone, smart phone, tablet or other such device. Like the previous embodiment, the holder 1″ includes a main opening or slot 18″ for receiving at least one card such as a credit card, debit card, or other such devices or card-shaped objects, a back side 16″ securable to the portable device, a front wall 15″, and a member or plate 30″ (shown is hidden lines) in FIG. 22 of the type described above. In addition, an adhesive backing or sheet 20″ is arranged on the back wall 16″ to allow the holder 1″ to be adhesively secured to a portable device PD. Like the previous embodiment, the holder 1″ can be made of a synthetic resin material such as silicone or rubber. The plate 30″ is sized and shaped to nest inside the wall 15′ of the holder 1′, is of sufficient size to encompass 75%, 80% or 90% or more of an area of the front wall 15″, and also has a mass and thickness to provide RFID shielding and/or to magnetically support the portable device PD when the holder 1″ is attached thereto and is magnetically attached to a magnetic mount. See example of FIG. 19.

In addition, this embodiment has an upper end 11″ that includes a curved notch 17″a as well as a lower end 12″ with an curved notch 17″b which allows a bottom middle portion of any inserted car to extend into the notch 17″b. This allows the user to more easily remove the card from the holder 1″ and provides a visual indicator to the user that the card is positioned inside the holder 1″.

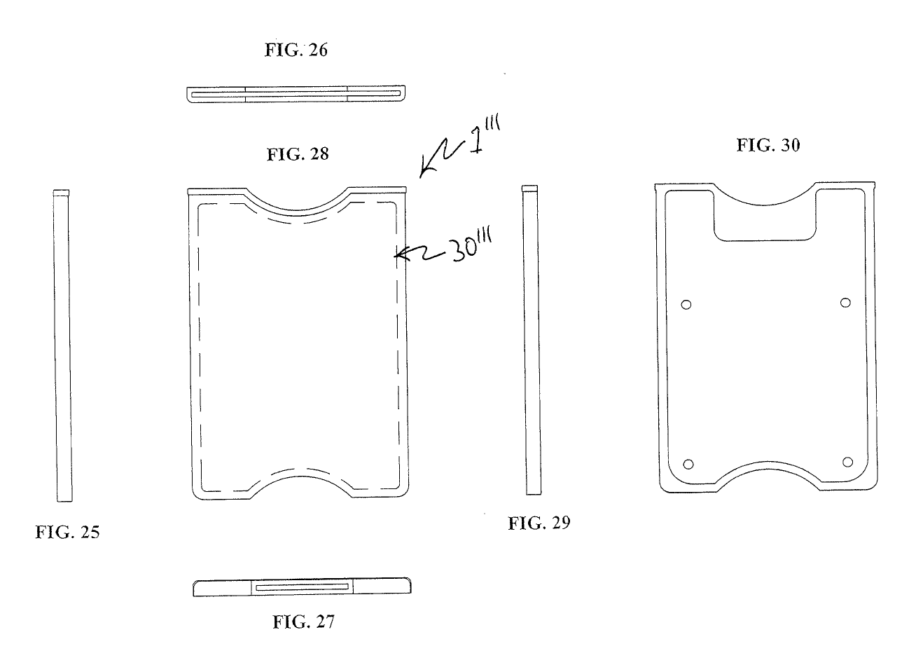

FIGS. 25-30 show another embodiment of a card holder 1″′ for a portable device PD which can be a portable electronic device such as a phone, smart phone, tablet or other such device. This holder 1″′ is similar to that of the previous embodiment except that the plate 30″′ covers a larger area of a wall of the holder 1″′ and is sized to extend around both the upper and lower curved notches.

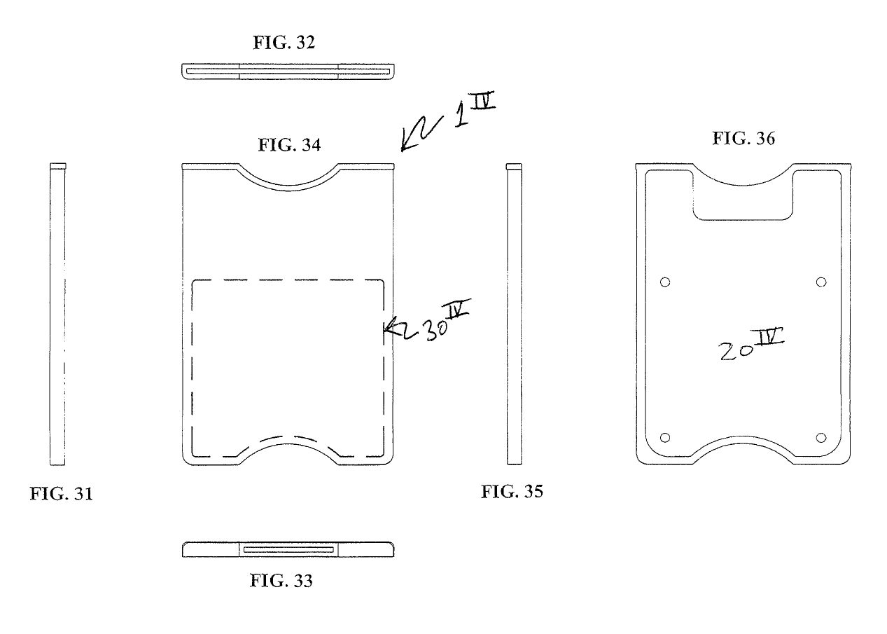

FIGS. 31-36 show another embodiment of a card holder 1^{IV} for a portable device PD which can be a portable electronic device such as a phone, smart phone, tablet or other such device. This holder 1^{IV} is similar to that of a previous embodiment except that the plate 30^{IV} covers a smaller area of a wall of the holder 1^{IV} and is sized to extend around only one of the curved notches. The size and location of the plate 30^{IV} can be tailored to type of portable device, to its center of mass, and/or type of cards retained inside the holder.

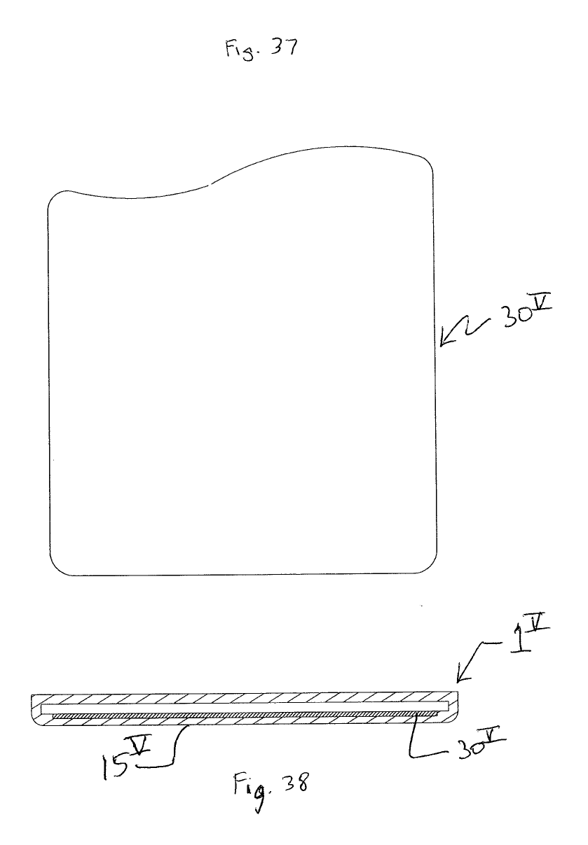

FIGS. 37 and 38 show another embodiment of a card holder for a portable device with FIG. 37 showing the shape of the plate 30^{V} and with FIG. 38 showing the plate of FIG. 37 arranged in a front wall of the holder 1^{V}. As should be apparent, this embodiment utilizes a plate 30^{V} whose thickness is in the range of half or less than half of the thickness of the front wall 15^{IV}.

Any one or more features of one embodiment may be utilized in any other embodiment. In addition, the holder can include features shown or disclosed in any of the documents incorporated by reference in this application. Non-limiting sized for the holder can include:

a length of between 2.5 and 5 inches with a length of about 3, 3.25 or 3.375 inches being preferred;

a width of between 2 and 3 inches with a width of about 2, 2.13 or 2.25 inches being preferred; and

a thickness of between ⅛ and ¼ inches with a thickness of about 3/16 inches being preferred.

Further, at least because the invention is disclosed herein in a manner that enables one to make and use it, by virtue of the disclosure of particular exemplary embodiments, such as for simplicity or efficiency, for example, the invention can be practiced in the absence of any additional element or additional structure that is not specifically disclosed herein.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

In the devices shown in the drawings, the features are designated as follows:

Magnetic mount

Portable device PD

Card holder 1

Upper end 11

Lower end 12

Left side 13

Right side 14

Front wall 15

Back wall 16

Notch 17

Card slot 18

Recess 19

Adhesive backing 20

Metal plate 30

What is claimed:

1. A card holder for a portable device, comprising:
a main opening or slot for receiving at least one card;
a back side securable to the portable device;
a front wall; and
a member or plate comprising at least one material that provides RF and/or RFID shielding and facilitates attachment to an external mount or magnetic surface.

2. The holder of claim 1, wherein the card holder is made of a synthetic resin.

3. The holder of claim 1, wherein the card holder is made of a silicone material.

4. The holder of claim 1, further comprising an adhesive layer arranged on the back side.

5. The holder of claim 1, further comprising a peel and stick adhesive sheet arranged on the back side.

6. The holder of claim 1, wherein the at least one material comprises one of:
a metal, ferrous metal, ferrous sheet metal or steel plate;
a galvanized sheet metal plate;
a sheet metal plate having a thickness of between 0.25 and 0.75 mm;
a metal plate of sufficient mass to allow for a portable device to which the metal plate is mounted or attached via the card holder to be magnetically supported or attached to a magnetic mount.

7. The holder of claim 1, wherein the member or plate is integrated into a body of the card holder.

8. The holder of claim 1, wherein the member or plate is integrated into the front wall of the card holder.

9. A method of securing a portable device to a magnetic mount comprising:
mounting the portable device to the magnetic mount using the card holder of claim 1.

10. A method of securing a portable device to a magnetic mount comprising:
securing the card holder of claim 1 to the portable device; and
mounting the portable device to the magnetic mount via the card holder.

11. A method of making the card holder of claim 1, the method comprising:
molding the card holder with the member or plate integrated or disposed therein.

12. A method of making the card holder of claim 1, the method comprising:
molding the card holder with the member or plate in-molded therein.

13. The holder of claim 1, wherein the member or plate is hidden or concealed inside the card holder.

14. A card holder for a portable device, comprising:
a main opening or slot for receiving at least one card;
a back side securable to the portable device;
a front wall; and
a member or plate covered by a portion of the front wall and being adapted to facilitate attaching of the card holder and to provide RF and/or RFID shielding.

15. The holder of claim 14, wherein the member or plate is hidden or concealed inside the card holder.

16. A flexible synthetic resin card holder for a portable device, comprising:
a main opening or slot for receiving at least one card;
a back side securable to the portable device;
a front wall; and
an internally disposed member or plate adapted to facilitate attachment to a magnetic surface and to provide RF and/or RFID shielding.

17. The holder of claim 16, wherein the attaching and RF/RFID shield member or plate is hidden or concealed inside the card holder.
